(19) United States
(12) Patent Application Publication
(10) Pub. No.: US 2023/0071084 A1
(43) Pub. Date: Mar. 9, 2023

(54) Sealing device between two conduits, in particular for transporting a fluid comprising a corrosive and/or abrasive component

(71) Applicant: TECHLAM, CERNAY (FR)

(72) Inventors: Olivier MOOG, KEMBS (FR); Michel GUY, Mulhouse (FR); Antoine PIASI, Walbach (FR); Mathieu GUILLOTIN, Mulhouse (FR)

(21) Appl. No.: 17/760,471

(22) PCT Filed: Feb. 14, 2020
(86) PCT No.: PCT/FR2020/050278

§ 371 Date: Aug. 10, 2022

(51) Int. Cl. F16L 58/18; F16L 15/00; F16L 15/04

(52) U.S. Cl. CPC F16L 58/182; F16L 15/001; F16L 15/04

(57) ABSTRACT

The invention relates to a scaling device (100) between two pipes (10, 20), each pipe comprising an internal coating (RI10, RI20) which is made from a material resistant to corrosion and/or abrasion, characterised in that the device (100) comprises at least one sealing line (L2, L2′) formed by a circumferential groove (12), which is made in the internal coating (RI10, RI20) of one of the two pipes (10, 20), receiving a circumferential protuberance (22) which is made in the internal coating (RI10, RI20) of the other of the two pipes (10, 20), the protuberance (22) being configured to mechanically interfere radially with the groove (12) over at least one circumferential zone (Z2, Z′2).

### TECHNICAL FIELD OF THE INVENTION

The present invention relates to the field of sealing between two conduits, and more particularly to maintaining the seal between two conduits intended for the transport of a fluid comprising a corrosive and/or abrasive component.

The fluid in question can in particular be gas, oil, water, for example transporting sand. In particular, in the gas or oil field, it should be noted that the underwater drilling are performed at ever greater depths, depths at which the fluid transported may comprise a chemically aggressive and/or mechanically aggressive component.

### TECHNICAL BACKGROUND

Throughout the following description, the AS axis defines an axis of symmetry of the conduits. The direction defined by this axis of symmetry AS is the axial direction. In fact, a radial direction is taken along the radius, with reference to the axis of symmetry AS. In fact, a circumference also defines the outline of the conduits, around the axis of symmetry AS.

FIG. 1 shows a solution of the prior art, according to a partial cross-sectional view.

On this FIG. 1, we note the presence of two conduits C1, C2 once connected to each other. The two conduits C1, C2 are of the same type and are connected end to end. To ensure the connection between the two conduits C1, C2, an annulus A is in particular equipped with means MC2, which come to fit into complementary means MC1 provided on each of the two conduits C1, C2. The inside of the conduits is referenced INT and the outside of the conduits is referenced EXT.

In order to ensure the sealing between the two conduits C1, C2, at least one sealing line L1 is provided between the two conduits C1, C2. The sealing line comprises a ring B which is made from a material resistant to corrosion. This ring B is designed to address the problems associated with the presence of a corrosive environment, in particular in the fluid transported inside the conduits.

The conduits shown in FIG. 1 are, during operation, subject to various forces, in particular axial forces and moments.

Thus, for example, when an axial force (axis X) tends to move the two conduits C1, C2 apart, the fluid transported inside the conduits tends to pass between the ring B and each conduit C1, C2. Also, a fluid containing a corrosive component can then end up at the level of the complementary means MC1, MC2, which are generally not made from a material resistant to the corrosion for cost reasons. This repeated action has an impact on the service life of the conduits C1, C2.

Furthermore, when the fluid being transported comprises an abrasive component, for example sand grains that would be carried in oil or gas from a seabed, this abrasive component can also be found at the level of the means MC1, MC2, which also has an impact on the service life of the conduits.

FIG. 2 shows another solution of the prior art, according to a partial cross-sectional view.

On this FIG. 2, we note the presence of two conduits C′1, C′2 once connected together. The conduit C′1 is a female conduit and the conduit C′2 is a male conduit. The connection between the two conduits C′1, C′2 is performed by complementary means (not shown), belonging respectively to the conduits C′1, C′2 and which fit into each other. These means are quite similar to the means MC1, MC2 previously described in support of FIG. 1. The inside of the conduits is referenced INT and the outside of the conduits is referenced EXT. Note the presence of a leakage line LF, which is useful to evacuate oil when mounting the two conduits one on the other. In use, the leakage line LF is closed.

The two conduits C′1, C′2 are in contact at the level of a flat, radially extending contact line LC.

In order to ensure the sealing between the two conduits C′1, C′2, a sealing line L′ is provided, which is formed by the forced insertion of a tab 21, which is made in the conduit C′2, with a gorge 11 thus receiving the tab 21.

Different shapes can be envisaged for the tab 21 and the corresponding gorge 11. For example, one can refer to the U.S. Pat. No. 9,828,812 B2 (D1).

The design shown in FIG. 2 (document D1) is theoretically more efficient in terms of sealing than the design shown in FIG. 1.

Thus, the contact line LC in the document D1 provides for an inner coating (cladding) of the conduits that is made from a material resistant to corrosion. This cladding can be made on the entire inner surface SI of the conduits C′1, C′2. This cladding can alternatively be made on the inner surface SI of the conduits C′1, C′2, but only locally at the level of the contact line LC. This cladding can also be extended into the contact line LC.

When an axial force (axis X) tends to move the two conduits C′1, C′2 apart, the fluid transported in the conduits can nevertheless pass at the level of the contact line LC. If the contact line LC comprises a corrosion-resistant cladding, then the sealing is already more effective than in the embodiment shown in FIG. 1. Furthermore, if this axial force is too great or if there is a moment that tends to rotate the two conduits relative to each other, the contact line fails, but the sealing line L′ can then fulfil its function, which is also advantageous compared to the design shown in FIG. 1.

However, when the sealing line L′ is repeatedly subjected to the fluid comprising a corrosive component, the design shown in FIG. 2 has the same disadvantages as the design shown in FIG. 1, because the sealing line L′ does not comprise a corrosion-resistant material. Also, a repeated presence of fluid containing a corrosive component, at the level of the mechanical interference area between the tab 21 and the gorge 11, has an impact on the service life of the conduits C′1, C′2.

A similar remark can be performed when the fluid transported by the conduits comprises an abrasive component.

There is therefore a need to improve the sealing between two conduits, in particular for transporting a fluid, such as oil or gas, comprising a corrosive and/or abrasive component.

### SUMMARY OF THE INVENTION

The purpose of the invention is to propose an improved sealing device between two conduits, in particular for transporting a fluid comprising a corrosive and/or abrasive component.

To this end, and in a first embodiment, the invention proposes a sealing device between two conduits, each conduit comprising an inner coating which is made from a material resistant to corrosion and/or abrasion, characterised in that the device comprises at least one sealing line formed by a circumferential groove, which is made in the inner coating of one of the two conduits, receiving a circumferential protuberance which is made in the inner coating of the other of the two conduits, said protuberance being configured so as to come into mechanical interference, radially, with the groove, over at least one circumferential area.

The device according to the first embodiment may comprise at least one of the following characteristics, taken alone or in combination:
said at least one sealing line is formed by a mechanical interference, radially, between the groove and the protuberance, by means of a protuberance having an outer radius, before mounting the conduits one on the other, greater than an outer radius of the groove;
said at least one sealing line is formed by a mechanical interference, radially, between the groove and the protuberance, by means of a protuberance having an inner radius, before mounting the conduits one on the other, smaller than an inner radius of the groove;
the device comprises at least two sealing lines formed by the circumferential groove and the circumferential protuberance, said protuberance being configured to come into mechanical interference, radially, with the groove, on at least two areas located on either side, radially, of said protuberance;
said at least two sealing lines are formed by a mechanical interference, radially, between the groove and the protuberance, by means of a protuberance having, on the one hand, an outer radius, before mounting the conduits one on the other, greater than an outer radius of the groove and having, on the other hand, an inner radius, before mounting the conduits one on the other, smaller than an inner radius of the groove;
the device comprises at least one additional sealing line, located radially inside said at least one sealing line, said at least one additional sealing line being formed by a circumferential recess, which is made in the inner coating of one of the two conduits, receiving a circumferential boss which is made in the inner coating of the other of the two conduits;
the device comprises at least one further additional sealing line located radially outside said at least one sealing line, said at least one other additional sealing line being formed by a circumferential recess, which is made in the inner coating of one of the two conduits, receiving a circumferential boss which is made in the inner coating of the other of the two conduits;
the boss of the or each additional sealing line is configured to come into mechanical interference, axially, with the recess over a circumferential area;
the boss of the or each additional sealing line is configured to come into mechanical interference, radially, with the recess, on at least two circumferential areas located on either side, radially, of the boss;
the device comprises another sealing line formed by a gorge which is made in the first conduit and receiving a tab which is made in the second conduit, said another sealing line being located radially outside the inner coating of said conduits;
the inner coating is made of stainless steel or based on an alloy comprising nickel and chromium.

To this end, and in a second embodiment, the invention concerns a sealing device between two conduits, each conduit comprising a radially internal wall portion of given thickness e and which is made of a sacrificial material, characterised in that the device comprises at least one sealing line formed by a circumferential groove, which is made radially outside and at the border of said wall portion of one of the two conduits, receiving a circumferential protuberance, which is made radially outside and at the border of said wall portion of the other of the two conduits, said protuberance being configured to come into mechanical interference, radially, with the groove over at least one circumferential area, said groove and said protuberance both being made from a material resistant to corrosion and/or abrasion.

The device according to the second embodiment may comprise at least one of the following characteristics, taken alone or in combination:
said at least one sealing line is formed by a mechanical interference, radially, between the groove and the protuberance, by means of a protuberance having an outer radius, before mounting the conduits one on the other, greater than an outer radius of the groove;
said at least one sealing line is formed by a mechanical interference, radially, between the groove and the protuberance, by means of a protuberance having an inner radius, before mounting the conduits one on the other, smaller than an inner radius of the groove;
the device comprises at least two sealing lines formed by the circumferential groove and the circumferential protuberance, said protuberance being configured to come into mechanical interference, radially, with the groove, on at least two areas located on either side, radially, of said protuberance;
said at least two sealing lines are formed by a mechanical interference, radially, between the groove and the protuberance, by means of a protuberance having, on the one hand, an outer radius, before mounting the conduits one on the other, greater than an outer radius of the groove and having, on the other hand, an inner radius, before mounting the conduits one on the other, smaller than an inner radius of the groove;
the device comprises at least one additional sealing line, located radially inside said at least one sealing line, said at least one additional sealing line being formed by a circumferential recess, which is made in one of the two conduits and receiving a circumferential boss, which is made in the other of the two conduits, said recess and said boss both being made from a material resistant to corrosion and/or abrasion;
the device comprises at least one other additional sealing line located radially outside said at least one sealing line, said at least one other additional sealing line being formed by a circumferential recess, which is made in one of the two conduits and receiving a circumferential boss, which is made in the other of the two conduits, said recess and said boss both being made from a material resistant to corrosion and/or abrasion;
the boss of the or each additional sealing line is configured to come into mechanical interference, axially, with the recess over a circumferential area;
the boss of the or each additional sealing line is configured to come into mechanical interference, radially, with the recess, on at least two circumferential areas located on either side, radially, of the boss;
the device comprises another sealing line formed by a gorge which is made in the first conduit and receiving a tab which is made in the second conduit, said another sealing line being located radially outside said at least one sealing line formed by the groove and the protuberance;
the material resistant to corrosion and/or abrasion is a stainless steel, or an alloy comprising Nickel and Chromium;
the sacrificial wall portion is in the form of an inner coating of the conduits, said inner coating being made of a material with low corrosion and/or abrasion resistance selected from: a non-stainless steel, an elastomer or a polymer

### BRIEF DESCRIPTION OF THE FIGURES

Further characteristics and advantages of the invention will become apparent from the following detailed description, for the understanding of which reference is made to the attached drawings, for which:

FIG. 1 shows a first solution of the prior art for ensuring the sealing between two conduits for the transport of oil or gas;

FIG. 2 shows a second solution of the prior art for ensuring the sealing between two conduits for the transport of oil or gas;

FIG. 3 is a cross-sectional view of a sealing device between two conduits for the transport of oil or gas, according to a first embodiment of the invention;

FIG. 4 is an enlarged cross-sectional view at the level of an interconnection area between two conduits of the device shown in FIG. 3;

FIG. 5 is an enlarged cross-sectional view of a sealing component shown in FIG. 4;

FIG. 6 is a cross-sectional view of a sealing device between two conduits for the transport of oil or gas, according to a second embodiment of the invention;

FIG. 7 is an enlarged cross-sectional view of a sealing component shown in FIG. 6;

FIG. 8 is an alternative embodiment of the invention, applicable to both of the above embodiments;

FIG. 9 is an enlarged view of FIG. 8;

FIG. 10 shows different possible designs, according to cross-sectional views, of sealing lines of a device according to the invention;

FIG. 11 shows a cross-sectional view of a variant embodiment of the sealing device shown in FIG. 3;

FIG. 12 shows a cross-sectional view of another variant of embodiment of the sealing device shown in FIG. 3;

FIG. 13 shows the positioning of the sealing means of the device of FIG. 3, with respect to the axis of symmetry of the conduits.

### DETAILED DESCRIPTION OF THE INVENTION

In all figures referred to in the following description, the reference EXT refers to the outside of the conduits and the reference INT refers to the inside of the conduits.

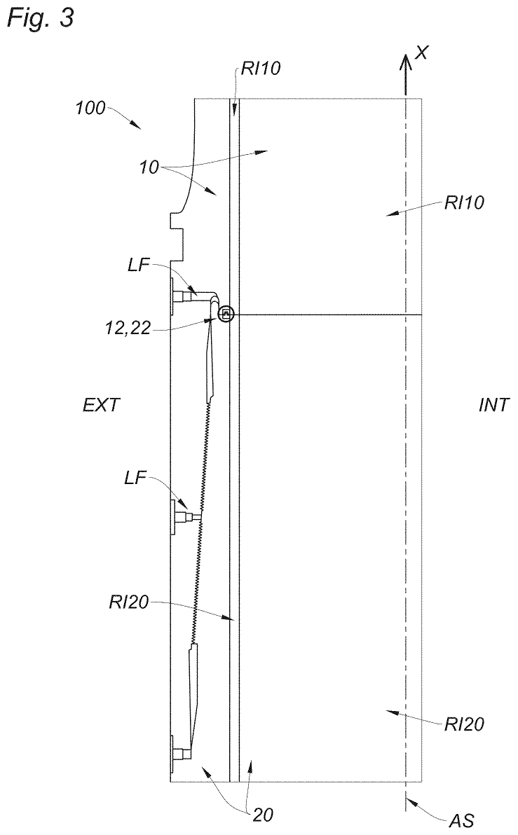

A first embodiment of the invention is shown in FIGS. 3 to 5.

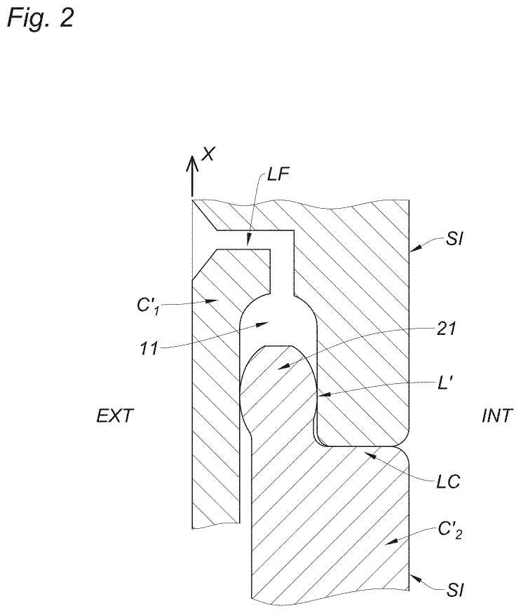

The device 100 comprises at least one first sealing line L1 formed by a gorge 11 which is made in the first conduit 10 and receiving a tab 21 which is made in the second conduit 20. The gorge 11 and the tab 21 advantageously extend over the entire circumference, in accordance with the prior art, for example as shown in FIG. 2.

Each conduit 10, 20 is equipped with an inner coating RI10, RI20 which is made from a material resistant to corrosion and/or abrasion. For example, it can be a stainless steel or an alloy of Nickel and Chrome.

The device 100 also comprises two additional sealing lines L2, L2′ located radially inside from the first sealing line L1.

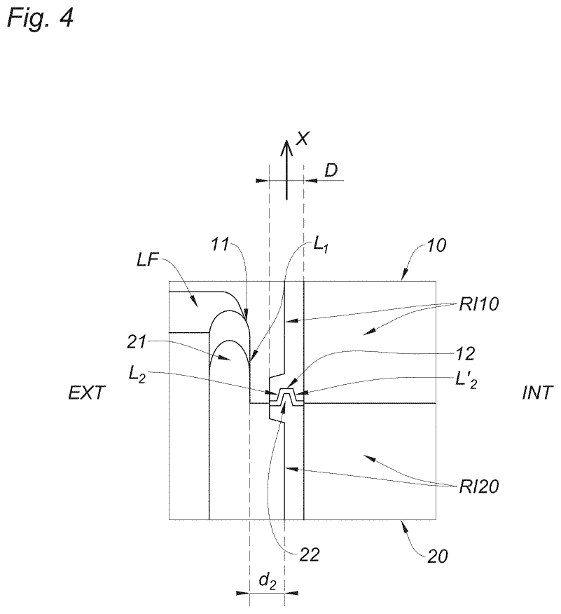

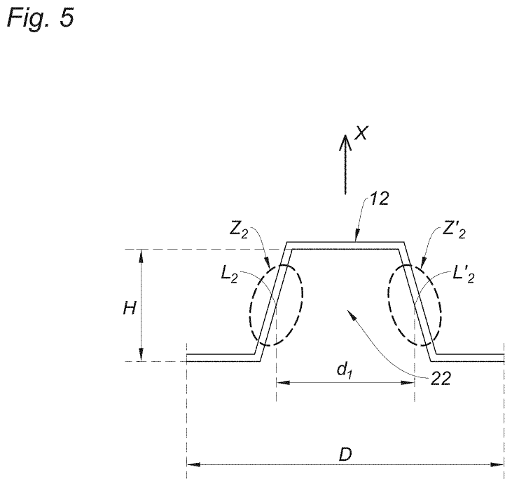

Each of the sealing lines L2, L′2 is formed by a circumferential groove 12, which is made in the inner coating RI10, RI20 of one of the two conduits 10, 20 receiving a circumferential protuberance 22 which is made in the inner coating RI10, RI20 of the other of the two conduits 10, 20. At the level of the groove 12 and the protuberance 22, the thickness D, taken radially, over which the inner coating RI10, RI 20 extends is typically at least 3 mm (see FIGS. 4 and 5). This thickness may be lower elsewhere, as can be seen from the attached figures.

Due to the positioning on the radially portion the most internal of the sealing lines L2, L′2, i.e. in the inner coating RI10, RI20 which is made from a material resistant to corrosion and/or abrasion, these sealing lines L2, L′2 are indeed likely to be subjected to oil or gas comprising a corrosive or abrasive component.

The protuberance 22 is further configured to mechanically interfere with the groove 12 on two circumferential areas Z2, Z2′ located on either side, radially, of the protuberance 22. It is this mechanical interference that allows to form each sealing line L2, L′2.

In FIG. 5, the groove 12 and the protuberance 22 have been shown slightly spaced for visibility. However, in operation, the areas Z2, Z′2 are indeed areas in which the groove 12 and the protuberance 22 interfere mechanically.

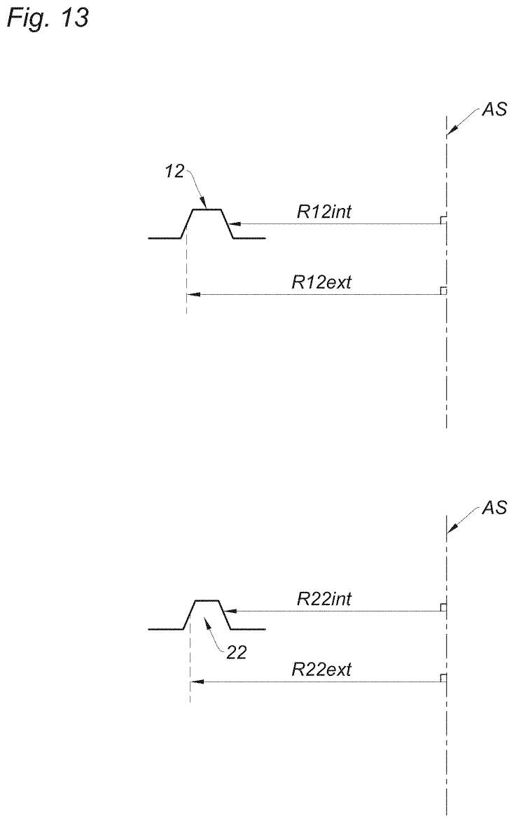

From a practical point of view, similar cross-sections can be envisaged for the groove 12 and the protuberance 22 (shaped like a trapezoidal in the example of FIG. 5), the cross-section of the protuberance 22 having, however, larger dimensions, before mounting of the conduits 10, 20 one on the other, to that of the cross-section of the groove 12 in order to ensure that the protuberance 22 is then force-mounted into the groove 12, and thus, after mounting, that there is a mechanical interference, which goes beyond a simple surface contact, which does not allow to define a sealing line. Because of the presence of these interference areas Z2, Z′2, there is in fact for each of these interference areas, a force with a significant radial component. To be more precise, and still from a practical point of view, the radial mechanical interference can be obtained by means of a protuberance 22 having, on the one hand, an outer radius R22ₑₓₜ, before mounting the conduits 10, 20 one on the other, greater than an outer radius R12ₑₓₜ of the groove 12 and having, on the other hand, an inner radius R22ᵢₙₜ, before mounting the conduits 10, 20 one on the other, smaller than an inner radius R12ᵢₙₜ of the groove 12. These different radii, defined before the mounting of one conduit on the other, are shown in FIG. 13. As an example, we can typically foresee that the quantity (R22ₑₓₜ−R12ₑₓₜ)+(R12ᵢₙₜ−R22ᵢₙₜ) is between 0.05 mm and 0.5 mm (each quantity in brackets is positive). Once the conduits are mounted one on the other, the protuberance 22 and/or the groove 12, which are force-mounted, are deformed, which in this case generates the mechanical interference at the level of said areas Z2, Z′2.

This design limits the risk of opening the sealing lines L2, L′2 under the effect of an axial force (axis X) between the two conduits 10, 20, for example, due to the forced mounting of the protuberance 22 in the groove 12. Indeed, under the effect of an axial force between the two conduits 10, 20, the interference areas Z2, Z′2 will move and their extent will be restricted, but a radial component of the forces exerted between the protuberance 22 and the groove 12 will be maintained.

Moreover, the presence of these two sealing lines L2, L′2 which are in fact, by the chosen design, radially offset (average distance d1, cf. FIG. 5) restricts the effect of a moment which would act to make one conduit rotate with respect to the other, in particular about an axis of rotation perpendicular to the plane of the attached figures and passing through the axis of symmetry AS of the device 100. In this case, such a moment tends to limit the mechanical interference force at the level of one of the two areas Z2, Z′2, but at the same time to reinforce this force (and thus the sealing capacity) at the other of the two areas Z2, Z′2 of mechanical interference.

In the scope of the invention, therefore, the sealing line L1 provides only an additional sealing line, which is ultimately not necessary, although advantageous for the reasons mentioned above.

However, the presence of the gorge 11/tab 21 assembly (sealing line L1) also provides a resistance to the separation of the two conduits 10, 20 under the effect of an axial force. In addition, the combined presence of on the one hand the assembly gorge 11/tab 21 (sealing line L1) and on the other hand the assembly groove 12/protuberance 22 (sealing lines L2, L′2) provides a better sealing behaviour when one of the two conduits 10, 20 is subjected to a moment with respect to the other conduit, since the sealing line L1 is radially offset (average distance d2, in FIG. 4) with respect to the other two sealing lines L2, L′2. This reinforces the previously explained effect on the better holding at a moment due to the radial offset between the two areas Z2, Z′2, being noted in particular that d2>d1.

It should be noted that the groove 12 and the protuberance 22 are made at the time of the manufacturing of the conduits 10, 20 and in particular of the inner coating RI10, RI20. No specific manufacturing step is therefore necessary to form the groove 12 and the protuberance 22. The distance D (see FIGS. 4 and 5) then defines the thickness of the inner coating RI10, RI20 at the level of the interconnection area between the two conduits 10, 20, an interconnection area comprising the groove 12 and the protuberance 20.

Note that typically, the protuberance 22 can have a height H (see FIG. 5) of between 2 mm and 4 mm. This height H also corresponds substantially to the depth of the groove 12 receiving the protuberance 22.

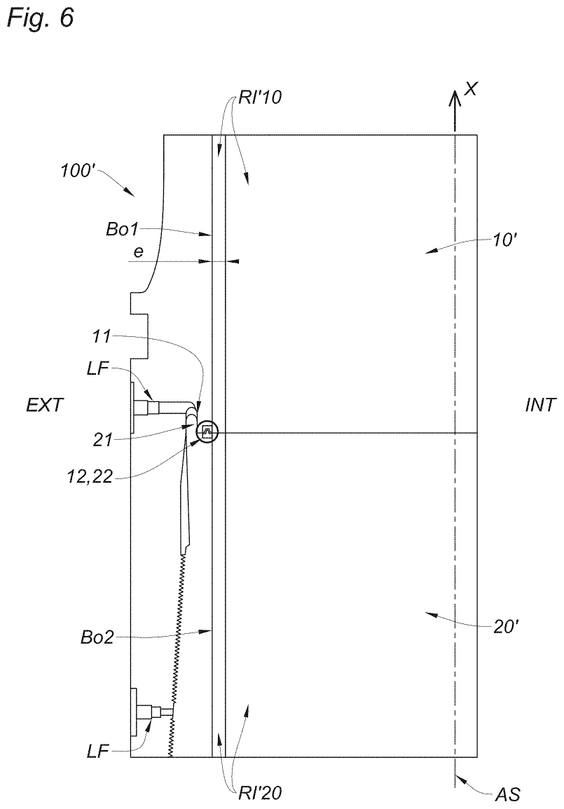

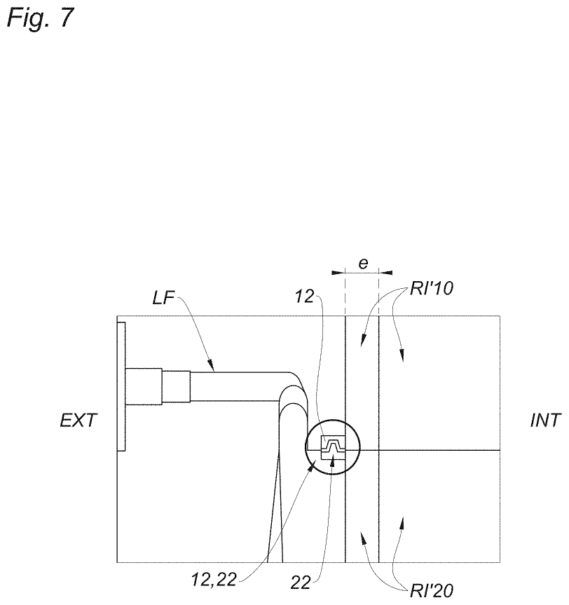

However, another design is possible, as shown in FIG. 6. Reference can also be made to FIG. 7, which is an enlargement of FIG. 6 at the level of the sealing area.

In this embodiment, the conduits 10′, 20′ of the device 100′ have a wall portion RI′10, RI′20 the most internal that is not very resistant to corrosion and/or abrasion.

This wall portion may be a simple allowance, of thickness e, of the wall forming each conduit 10′, 20′. It can then be made of a steel that is not stainless. Alternatively, it can be an inner coating, of thickness e, for example made of elastomer or polymer.

The interest of this design, compared to the one in FIG. 3, lies in the lower cost of this wall portion RI′10, RI′20. This wall portion RI′10, RI′20 then defines a circumferential slice of given thickness e, taken radially, referred to as sacrificial. Indeed, the wall portion RI′10, RI′20 being made of a material not very resistant to corrosion and/or abrasion, it is destined, in operation, to disappear.

Therefore, here, the sealing lines L2, L′2, which are made with a groove 12 and a protuberance 22 similar to those previously described for the first embodiment of FIG. 3, are made radially outside the sacrificial wall portion RI′10, RI′20. The groove 12 is also made at the border BO1 of the wall portion RI′10 and the protuberance 22 at the border BO2 of the wall portion RI′20. Thus, when the wall portion RI′10, RI′20 has completely disappeared after a certain period of use, the sealing lines L2, L′2 are in a situation close to that of the same sealing lines in the embodiment of FIG. 3. When, however, the gorge 11/tab 21 assembly forming the sealing line L1 is provided, which is the case in FIG. 6, the sealing lines are located radially inside of the sealing line L1. Note that the thickness e of the sacrificial wall portion RI′10, RI′20 is typically between 3 mm and 5 mm. This range of values is based on the fact that the sacrificial wall thickness that is consumed each year in contact with a corrosive and/or abrasive fluid is typically between 0.1 mm and 0.3 mm for a total service life generally between 20 years and 30 years.

Everything described above for the first embodiment described in support of FIG. 3 is then applicable here. In particular, both the groove 12 and the protuberance 22 remain made from a material resistant to corrosion and/or abrasion, and advantageously, both corrosion and abrasion resistant. In particular also, the groove 12 and the protuberance 22 allow the formation of areas Z2, Z′2 of mechanical interference, as previously defined.

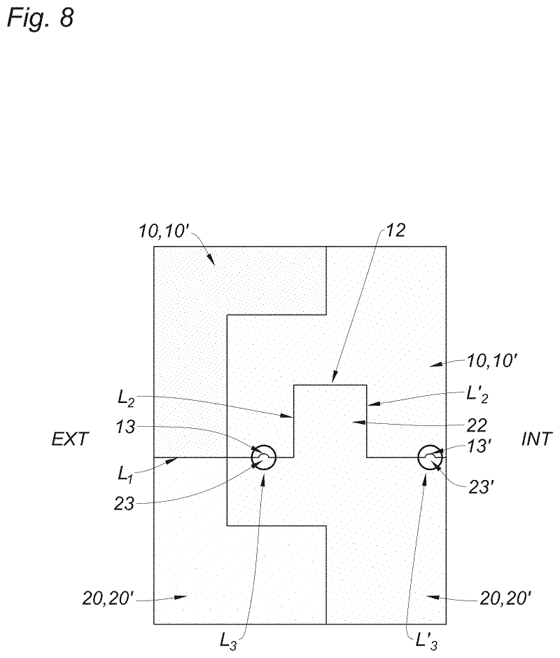

FIG. 8 shows a schematic cross-section of a sealing area between the two conduits.

This variant applies equally to the embodiments described in support of FIG. 3 or FIG. 6. FIG. 8 shows the groove 12 and the protuberance 22, both square and defining the two sealing lines L2, L′2.

To these sealing lines L2, L′2, it is possible to add one or more others.

Thus, in FIG. 8, an additional sealing line L′3 is shown, located radially inside of the sealing lines L2, L′2. The additional sealing line L′3 is for example formed by a circumferential recess 13′, which is made in one of the two conduits 10, 20 (in this case the female conduit 10, 10′) receiving a circumferential boss 23′ which is made in the other (in this case the male conduit 20, 20′) of the two conduits 10, 20.

The recess 13′ and the boss 23′ are furthermore both made from a material resistant to corrosion and/or abrasion, either because they are integrated into the inner coatings RI10, RI20, which are made of a corrosion and/or abrasion resistant material (FIG. 3), or because they are defined in the area made of such a material, radially external with respect to the wall portions RI′10, RI′20 (FIG. 6) of the conduits 10′, 20′.

Thus also, still in FIG. 8, another additional sealing line L3 has been shown, located radially outside the sealing lines L2, L′2, but also radially inside the sealing line L1, since the latter is provided in this FIG. 8. The additional sealing line L3 is for example formed by a circumferential recess 13, which is made in one of the two conduits 10 (or 10′), 20 (or 20′) (in this case the female conduit 10, 10′) receiving a circumferential boss 23 which is made in the other (in this case the male conduit 20, 20′) of the two conduits. Both the recess 13 and the boss 23 are furthermore made from a material resistant to corrosion and/or abrasion, similar to what has been explained for the sealing line L′3. In particular, the recesses 13, 13′ on the one hand and the bosses 23, 23′ on the other hand can each have an identically shaped cross-section.

It is possible to provide only the sealing line L3, or only the sealing line L′3 and advantageously both.

In any case, a boss 23 (respectively 23′) may have a height h typically between 0.05 mm and 0.3 mm. The depth of a recess 13 (respectively 13′) is of comparable size.

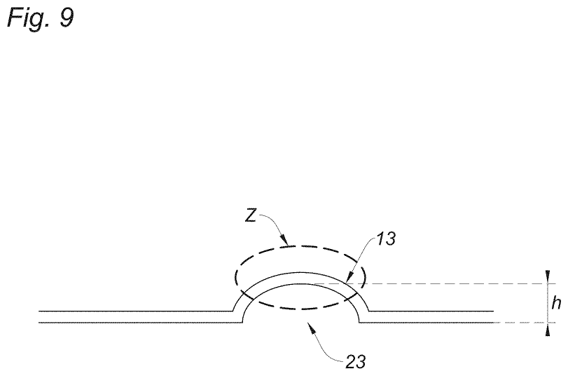

A boss 23 (respectively 23′) and a recess 13 (respectively 13′) can be complementary in shape, with an axial forced nesting only, i.e. with an axial mechanical interference only, on an area noted Z. There is then no radial mechanical interference. This is shown in FIG. 9, which is an enlargement of FIG. 8 at the level of the additional sealing line L3. The boss 23 and the recess are shown slightly separated for a better visibility, but when mounted one in the other, this is not the case at the level of the area Z.

However, the boss 23 (respectively 23′) of the additional sealing line L3 (respectively L′3) can also be configured to mechanically interfere with the recess 13 (respectively 13′) on two circumferential areas Z3, Z′3 located on both sides, radially, of the boss 13 (respectively 13′). From a practical point of view, it is sufficient for the radial dimension of the boss 23 (respectively 23′) to be greater than the corresponding radial dimension of the recess 13 (respectively 13′). The effects obtained are then of the same nature as those mentioned previously for the mechanical interference areas Z2, Z′2 between the groove 12 and the protuberance 22 (see FIG. 5). A boss 23, 23′ and a recess 13, 13′ may then have square, rectangular or rounded cross-sections. It is not necessary for all of them to have cross-section of the same shape.

This also applies to a protuberance 22 and a groove 12.

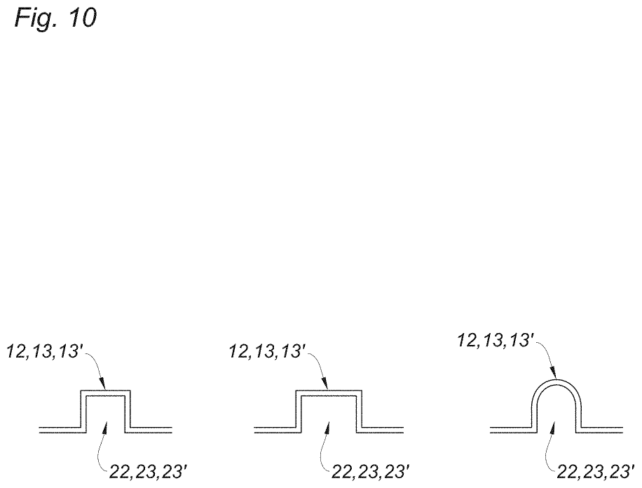

FIG. 10 shows some examples of possible shapes, before mounting, from left to right: square, rectangular, rounded.

It will be noted that in the appended figures relating to the invention, the male portion of each sealing line L2, L′2, L3 or L′3 is shown on the same conduit 20, 20′.

This is only illustrative.

In fact, there is nothing to prevent the male and female portions of the components allowing to form these sealing lines from being reversed within the scope of the invention. In particular, in the case of the embodiment shown in FIG. 3, both the groove 12 and the recess 13, 13′ can be located on the male conduit 20, and consequently both the protuberance 22 and the boss 23, 23′ can be located on the female conduit 10.

In the foregoing description, two embodiments are shown in each of which the sealing device 100, 100′ respectively comprises at least two sealing lines L2, L′2.

This is advantageous, but not essential for the invention.

Indeed, the invention may provide only one sealing line L2 or L′2.

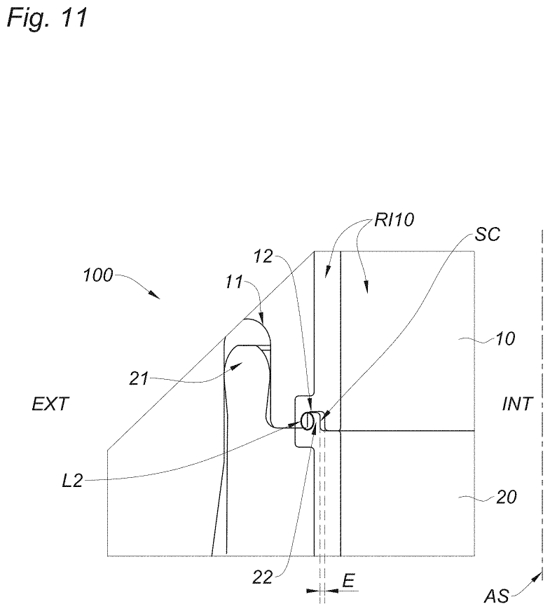

Thus, an alternative embodiment of the sealing device 100 of FIG. 3 is shown in FIG. 11, in which only the sealing line L2 is provided between the circumferential groove 12 and the circumferential protuberance 22. On the opposite side, radially, of the groove 12 and the protuberance 22, there is a non-zero space E. As a result, there is mechanical interference between the groove 12 and the protuberance 22 only at the level of the area Z2, defining the sealing line L2. From a practical point of view, this can be achieved by means of a protuberance 22 having an external radius R22ₑₓₜ, before mounting the conduits 10, 20 one on the other, greater than an outer radius R12ₑₓₜ of the groove 12, each radius being taken with reference to the axis of symmetry AS of the conduits 10, 20. This ensures a mechanical interference between the groove 12 and the protuberance 22 at the level of the radially area the most external of these. This implies the existence of a force with a radial component between the groove 12 and the protuberance 22. This effectively corresponds to the sealing line L2 as shown in FIG. 3. It is of course recalled that in this variant also, the groove 12 and the protuberance 22 are made in the inner coating RI10, RI20, which is made from a material resistant to corrosion and/or abrasion.

In this embodiment, if pressurized fluid manages to pass through the space E, it then only enhances the effectiveness of the sealing line L2 by pressing on the radially circumferential surface SC of the protuberance 22 the most internal.

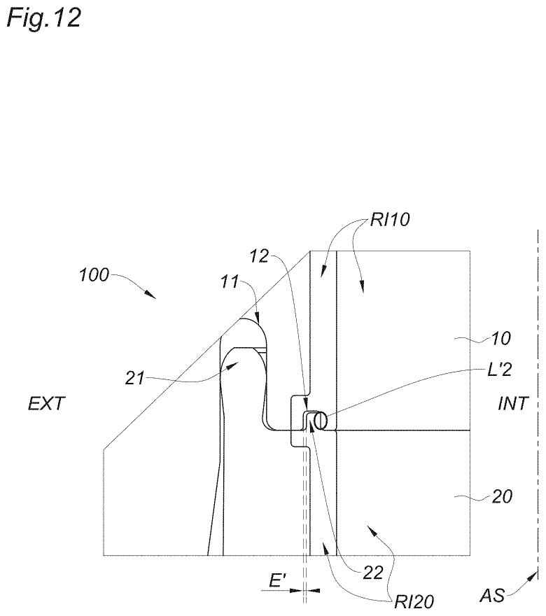

In FIG. 12, another variant of the sealing device 100 of FIG. 3 is shown, in which only the sealing line L′2 is provided between the circumferential groove 12 and the circumferential protuberance 22. On the opposite side, radially, of the groove 12 and the protuberance 22, there is a non-zero space E′. As a result, there is a mechanical interference between the groove 12 and the protuberance 22 only at the level of the area Z′2, defining the sealing line L′2. From a practical point of view, this can be achieved by means of a protuberance 22 having an inner radius R22ᵢₙₜ, before mounting the conduits 10, 20 one on the other, smaller than an inner radius R12ᵢₙₜ of the groove 12, each radius being taken with reference to the symmetry axis AS of the conduits 10, 20. This ensures a mechanical interference between the groove 12 and the protuberance 22 at the level of the area Z′2 the most internal radially of these. This implies the existence of a force with a radial component between the groove 12 and the protuberance 22. This effectively defines the L′2 sealing line. It is of course recalled that in this variant also, the groove 12 and the protuberance 22 are made in the inner coating RI10, RI20, which is made from a material resistant to corrosion and/or abrasion.

In contrast to the variant shown in FIG. 11, however, such a design is still to be considered for a fluid transported in the conduits with lower pressure.

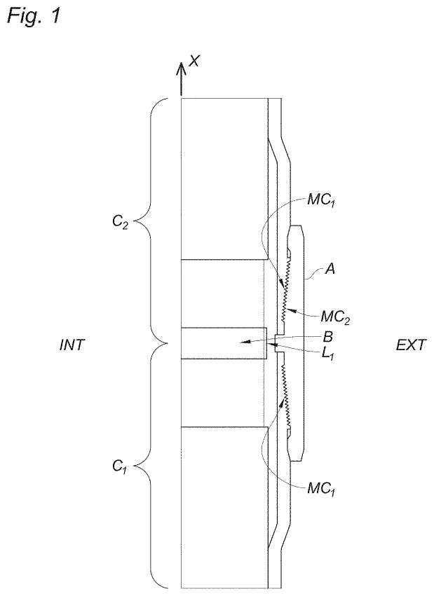

It is understood that the invention, whatever its embodiment, could equally be applied to conduits C1, C2 such as those shown in FIG. 1, with or without a ring B moreover. The way the conduits are connected is not important.

The invention relates, in its greatest generality, only to the provision of at least one sealing line L2 or L′2 on the inner side INT of the conduits.

Finally, it should be noted that in the scope of the invention, the mounting of the two conduits one on the other for the purpose of ensuring the sealing between these conduits is particularly easy.

Thus, the invention also proposes a method for mounting a device 100, 100′ according to the invention comprising a step in which the sealing lines L2, L′2 are formed by inserting the protuberance 22 into the groove 12, sometimes with force depending on the embodiment considered. When the sealing line L1 is provided, said step is also performed concomitantly with the step of forming the first sealing line L1 during which the tab 21 is positioned with force in the gorge 11.

The design proposed in the scope of the invention therefore has no impact on the mounting of the conduits.

Finally, the invention will advantageously apply to the conduits intended for the transport of a fluid comprising a corrosive and/or abrasive component. This is particularly true for the transport of gas or oil, in particular in a submarine environment.

1-23. (canceled)

24. A sealing device between two conduits, each conduit comprising an inner coating which is made from a material resistant to corrosion and/or abrasion, characterised in that the device comprises at least two sealing lines formed by a circumferential groove which is made in the inner coating of one of the two conduits and a circumferential protuberance received by the circumferential groove and which is made in the inner coating of the other of the two conduits, said protuberance being configured so as to come into mechanical interference, radially, with the groove, over at least two circumferential areas located on either side, radially, of said protuberance.

25. The device according to claim 24, characterised in that one of said at least two sealing lines is formed by a mechanical interference, radially, between the groove and the protuberance, by a protuberance having an outer radius, before mounting the conduits one on the other, greater than an outer radius of the groove.

26. The device according to claim 24, characterised in that one of said at least two sealing lines is formed by a mechanical interference, radially, between the groove and the protuberance, by a protuberance having an inner radius, before mounting the conduits one on the other, smaller than an inner radius of the groove.

27. The device according to claim 24, characterised in that said at least two sealing lines are formed by a mechanical interference, radially, between the groove and the protuberance, by a protuberance having, on the one hand, an outer radius, before mounting the conduits one on the other, greater than an outer radius of the groove and, on the other hand, having an inner radius, before mounting the conduits one on the other, smaller than an inner radius of the groove.

28. The device according to claim 24, characterised in that it comprises at least one additional sealing line, located radially inside said at least one sealing line, said at least one additional sealing line being formed by a circumferential recess, which is made in the inner coating of one of the two conduits, receiving a circumferential boss which is made in the inner coating of the other of the two conduits.

29. The device according to claim 24, characterised in that it comprises at least one further additional sealing line located radially outside said at least one sealing line, said at least one other additional sealing line being formed by a circumferential recess, which is made in the inner coating of one of the two conduits, receiving a circumferential boss which is made in the inner coating of the other of the two conduits.

30. The device according to claim 28, characterised in that the boss of the or each additional sealing line is configured to come into mechanical interference, axially, with the recess over a circumferential area.

31. The device according to claim 28, characterised in that the boss of the or each additional sealing line is configured to come into mechanical interference, radially, with the recess, on at least two circumferential areas located on either side, radially, of the boss.

32. The device according to claim 24, characterised in that it comprises another sealing line formed by a gorge which is made in the first conduit and receiving a tab which is made in the second conduit, said another sealing line being located radially outside the inner coating of said conduits.

33. The device according to claim 24, characterised in that the inner coating is made of stainless steel or based on an alloy comprising nickel and chromium.

34. A sealing device between two conduits, each conduit comprising a radially internal wall portion of given thickness e and made of a sacrificial material, characterised in that the device comprises at least two sealing lines formed by:
a circumferential groove, which is made radially outside and at the border of said wall portion of one of the two conduits, and
a circumferential protuberance received by the circumferential groove and which is made radially outside and at the border of said wall portion of the other of the two conduits, said protuberance being configured to come into mechanical interference, radially, with the groove over at least two circumferential areas located on either side, radially, of said protuberance,
said groove and said protuberance being made from a material resistant to corrosion and/or abrasion.

35. The device according to claim 34, characterised in that one of said at least two sealing lines is formed by a mechanical interference, radially, between the groove and the protuberance, by a protuberance having an outer radius, before mounting the conduits one on the other, greater than an outer radius of the groove.

36. The device according to claim 34, characterised in that one of said at least two sealing lines is formed by a mechanical interference, radially, between the groove and the protuberance, by a protuberance having an inner radius (R22int), before mounting the conduits one on the other, smaller than an inner radius (R12int) of the groove.

37. The device according to claim 34, characterised in that said at least two sealing lines are formed by a mechanical interference, radially, between the groove and the protuberance, by a protuberance having, on the one hand, an external radius, before mounting the conduits one on the other, greater than an outer radius of the groove and, on the other hand, has an inner radius, before mounting the conduits one on the other, smaller than an inner radius of the groove.

38. The device according to claim 34, characterised in that it comprises at least one additional sealing line, located radially inside said at least one sealing line, said at least one additional sealing line being formed by a circumferential recess, which is made in one of the two conduits and receiving a circumferential boss, which is made in the other of the two conduits, said recess and said boss both being made from a material resistant to corrosion and/or abrasion.

39. The device according to claim 34, characterised in that it comprises at least one other additional sealing line located radially outside said at least one sealing line, said at least one other additional sealing line being formed by a circumferential recess, which is made in one of the two conduits and receiving a circumferential boss, which is made in the other of the two conduits, said recess and said boss both being made from a material resistant to corrosion and/or abrasion.

40. The device according to claim 38, characterised in that the boss of the or each additional sealing line is configured to come into mechanical interference, axially, with the recess over a circumferential area.

41. The device according to claim 38, characterised in that the boss of the or each additional sealing line is configured to come into mechanical interference, radially, with the recess, on at least two circumferential areas located on either side, radially, of the boss.

42. The device according to claim 34, characterised in that it comprises another sealing line formed by a gorge which is made in the first conduit and receiving a tab which is made in the second conduit, said another sealing line being located radially outside said at least one sealing line formed by the groove and the protuberance.

43. The device of claim 34, characterised in that the material resistant to corrosion and/or abrasion forming is a stainless steel, or an alloy comprising Nickel and Chromium.

44. The device (100′) according to claim 34, characterised in that the sacrificial wall portion is in the form of an inner coating of the conduit, said inner coating being made of a material with low resistance to corrosion and/or abrasion selected from: a non-stainless steel, an elastomer or a polymer.
